(19) United States
(12) Patent Application Publication
(10) Pub. No.: US 2015/0254740 A1
(43) Pub. Date: Sep. 10, 2015

(54) Non-Intrusive Cloud Services Billing

(71) Applicant: International Business Machines Corporation, Armonk, NY (US)

(72) Inventors: Rahul P. Akolkar, Tuckahoe, NY (US); Paula K. Austel, Cortlandt Manor, NY (US); Thomas A. Mikalsen, Cold Spring, NY (US); Jonathan P. Munson, Putnam Valley, NY (US); Randy A. Rendahl, Raleigh, NC (US); Isabelle M. Rouvellou, New York, NY (US); Alla Segal, Mount Kisco, NY (US); Ignacio Silva-Lepe, Putnam Valley, NY (US); Hidayatullah Shaikh, Shrub Oak, NY (US); Revathi Subramanian, White Plains, NY (US); Xiao H. Shen, Shanghai (CN)

(73) Assignee: International Business Machines Corporation, Armonk, NY (US)

(21) Appl. No.: 14/199,330

(22) Filed: Mar. 6, 2014

(51) Int. Cl. G06Q 30/04

(52) U.S. Cl. CPC G06Q 30/04

(57) ABSTRACT

An embodiment of the invention provides a method for non-intrusive cloud services billing, including storing service log files in a data store, wherein each of the service log files include a lifecycle event of a resource in a service produced by an instance of the service. A log transformer connected to the data store converts the service log files into a standardized format. A metering descriptor describing billable entities for each offering of the service is obtained, wherein each offering of the service has a different metering descriptor, and wherein the billable entities include multiple categories of billing. A billing record generator connected to the log transformer is programmed, wherein the billing record generator converts standardized log records into metering records. The billing record generator generates a metering record with one or more of the service log files in the standardized format and the metering descriptor.

### BACKGROUND

The present invention is in the field of systems, methods, and computer program products for non-intrusive cloud services billing.

Services billing is different from billing for infrastructure resources, because a service can include a group of infrastructure resources and/or other service level resources that the infrastructure does not know about. Therefore, billable entities can be defined in the context of services, and a charge is applied to them.

For example, a service can be a hosted business process editor service. A customer who creates and stores up to 50 business process models is charged $X, customers with 50-100 models are charged $Y, and so on. In this case, the charge is applied to the maximum number of business process models that were in storage in a given billing cycle.

In another example, the service does some intensive data processing. Each service instance can consist of a cluster of virtual machines and some associated storage. The charge is applied to a combination of infrastructure resources in this case. For instance, the customer pays $X for a 5 VM cluster with 1 TB storage, or $Y for a 10 VM cluster with 5 TB storage. This charge is at the service level, and may be quite different from what the infrastructure cost is for the given group of resources.

### SUMMARY OF THE INVENTION

An embodiment of the invention provides a method for non-intrusive cloud services billing, including storing service log files in a data store, wherein each of the service log files include a lifecycle event of a resource in a service produced by an instance of the service. A log transformer connected to the data store converts the service log files into a standardized format. A metering descriptor describing billable entities for each offering of the service is obtained, wherein each offering of the service has a different metering descriptor, and wherein the billable entities include multiple categories of billing. A billing record generator connected to the log transformer is programmed, wherein the billing record generator converts standardized log records into metering records. The billing record generator generates a metering record with one or more of the service log files in the standardized format and the metering descriptor, wherein the metering record includes a billable entity, a event, and event data.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a system and method for non-intrusive cloud services billing according to an embodiment of the invention;

FIG. 2A illustrates a service descriptor according to an embodiment of the invention;

FIG. 2B illustrates another service descriptor according to an embodiment of the invention;

FIG. 3 illustrates an excerpt from a log file according to an embodiment of the invention;

FIG. 4 illustrates a command line tool according to an embodiment of the invention;

FIG. 5 illustrates a standardized log according to an embodiment of the invention;

FIG. 6 illustrates a metering descriptor according to an embodiment of the invention;

FIG. 7 illustrates pseudocode according to an embodiment of the invention;

FIG. 8 illustrates sets that result from application of the pseudocode illustrated in FIG. 7 to the standardized log excerpt illustrated in FIG. 3 according to an embodiment of the invention;

FIG. 9 illustrates an example metering record according to an embodiment of the invention;

FIG. 10 is a diagram illustrating a system for non-intrusive cloud services billing according to an embodiment of the invention;

FIG. 11 is a flow diagram illustrating a method for non-intrusive cloud services billing according to an embodiment of the invention;

FIG. 12 is a diagram illustrating a system and method for deployment according to an embodiment of the invention;

FIG. 13 is a diagram illustrating a system and method for integration according to an embodiment of the invention;

FIG. 14 is a diagram illustrating a system and method for on demand according to an embodiment of the invention;

FIG. 15 is a diagram illustrating a system and method for a virtual private network service according to an embodiment of the invention; and

FIG. 16 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention defines a system and method in which existing services can be augmented with billing functions without requiring a change to the service logic. Thus, the system allows billing plans to change without the service having to be rewritten, and allows for billing plans to be advertised and communicated declaratively. The system further provides a default billing function for services, for example, a sum of billing functions of any infrastructure resources used. The system allows services to tag service level resources, and allows billing functions of services to include references to the billing functions of composed resources.

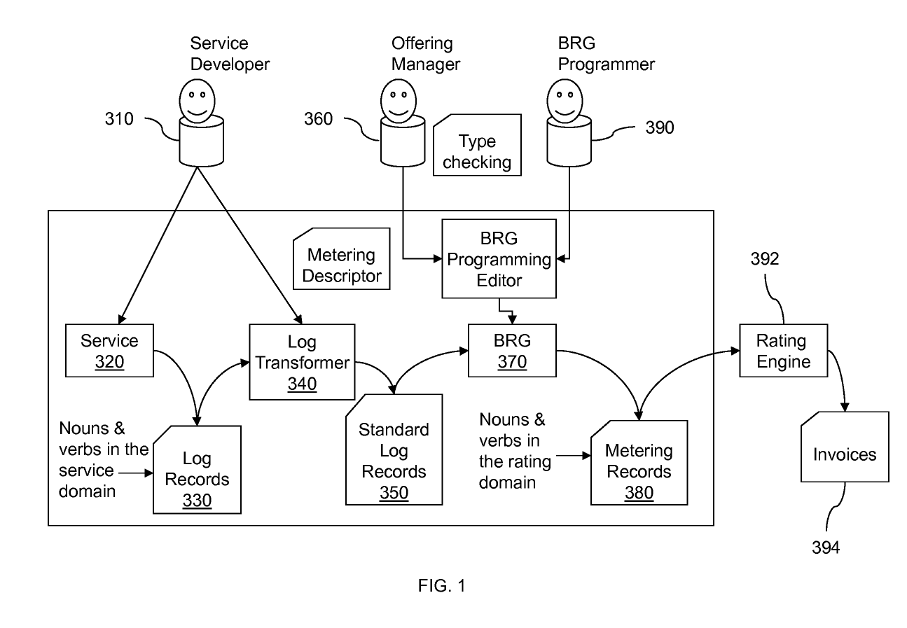

FIG. 1 illustrates a system and method for non-intrusive cloud services billing according to an embodiment of the invention, wherein service providers 330 (also referred to herein as “service developers”) list resources in a service descriptor. A resource can be a logical or physical resource that is created or manipulated by a service. For example, a subscription service may deal with the following resources: “users”, “subscriptions”, and “discounts”.

Service providers 330 can include organizations that develop and deliver services 320 (e.g., software services) on a services platform. A service 320 can be a collection of infrastructure components (e.g., virtual machines (VMs), storage, IP addresses, etc.), middleware components (e.g., application servers, databases, etc.) and/or application components (e.g., payroll, online transaction processing (OLTP), social media, etc.) that offers a certain business value. The services platform is a platform that can allow on-boarding, hosting and delivery of services 320.

Service providers 330 can develop their services 320 in such a manner that resource lifecycle events are logged in log records 330. The services platform can publish a specification of the standard log record format. Moreover, the services platform and/or service providers 330 can provide a log transformer 340 that can be programmed to transform the service's logs into a standardized format, which can be stored in standard log records 350. Service providers may program and configure the log transformer 330 for their service logs.

A service log can be a set of log files or log records produced by an instance of a service 320 in the course of its operation. A standardized service log can be a service log that is in a format that is understood by the services platform. A standardized service log specification can be a document that describes the nature and format of the standardized service log. The standardized service log specification can be published by the services platform.

The offering manager 360 can include one or more individuals that are responsible for setting up different offering plans for a service 320, and for determining the rating and pricing models for each offering. An offering can be a package that includes a set of service functions and a supported billing plan. For example, the same service may be offered as a “free trial for 30 days”, a “pay as you go (PAYG) basic”, or a “PAYG Advanced”. Offering managers 360 may describe billable entities, events, or usages for each service offering in a metering descriptor.

A billing record generator (BRG) 370 can be a programmable entity in the services platform that can automatically transform a standardized service log into a metering record 380. Offering managers 360 and/or a BRG programmer 390 may program the BRG 360 for a specific service offering.

At runtime, a service 320 can log the key lifecycle events for its resources, and service logs can be transformed into a standard format periodically. At least once in the billing cycle, the programmed BRG 370 can transform the service logs into metering records, so that a rating engine 392 can produce invoices 394. Such transformation can occur at predetermined time intervals or after a predetermined number of service log files have been converted.

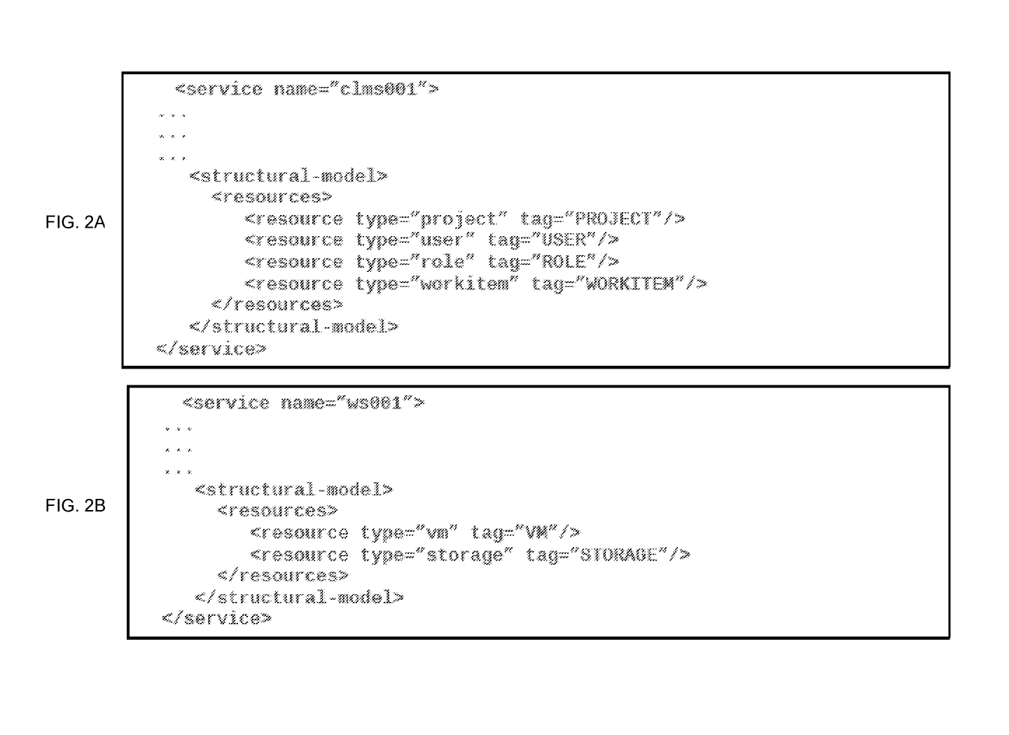

In at least one embodiment, the service providers create service descriptors one per service, wherein the services are described in terms of “resources” (need not be infrastructure resources). These resources can be the core building blocks that the service manipulates. For a given version of a service, a list of these resources can be absolute. This resource listing can be included in the service descriptor's structural model. FIGS. 2A and 2B illustrate two service descriptors according to an embodiment of the invention.

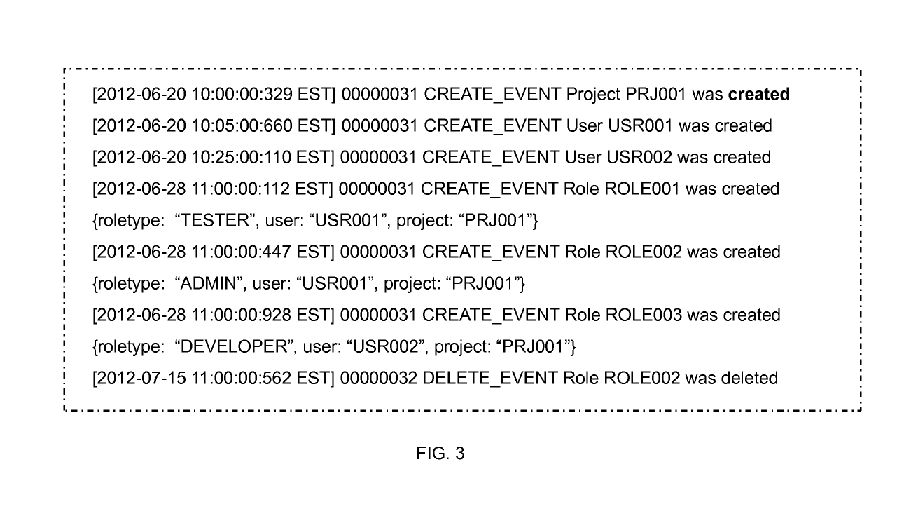

The service providers can develop their services in such a manner that resource lifecycle events are always logged. An excerpt from a sample log file is illustrated in FIG. 3. The log can record lifecycle events about key resources. In this example, “Project”, “User”, and “Role” are the resources that are declared in the structural model of the service descriptor (see FIG. 2A). The service providers can secure their logs so that resource lifecycle events are not tampered with resulting in incorrect metering records.

In at least one embodiment, the services platform publishes a specification of the standard log record format, wherein the services platform can choose any format, for example, relational database tables with well documented columns, XML, or any other proprietary format. The services platform can provide one or more tools that can help service providers transform their logs into that format. The following provides a sample specification for a relational database format:

TABLENAME: Standardized_Log_Records

COLUMNS

ResID: The Identifier of the resource

ResName: The Name of the resource

ResType: The type of the resource. This should map to the resource tags in your service descriptor.

ResAction: The lifecycle event associated with the resource (CREATE/DELETE/ . . . )

ActionTimestamp: The time of the lifecycle event

ServiceID: The ID of the service whose logs are being proceed. This row is automatically filled out and cannot be programmed.

ResContext: Any additional context information. Typically, this will include data that describes the lifecycle event or relates two or more resources.

Based on the sample specification, it should be understood that different mixtures and orders of the columns may be used in addition to further columns being added.

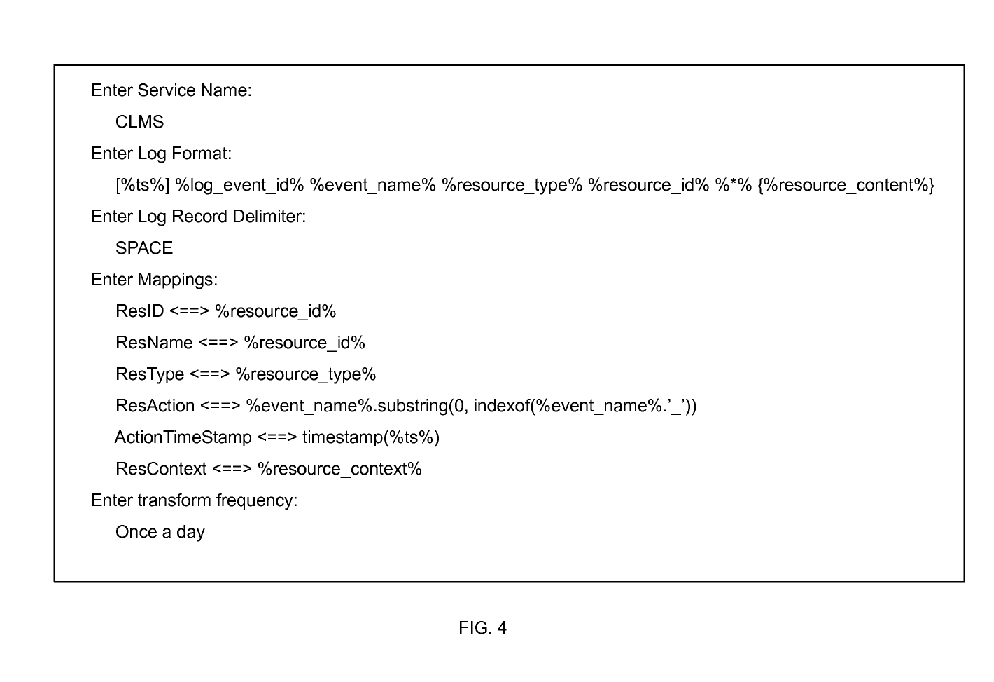

The log transformer can be a configurable component or service of the services platform that transforms a service's log records into a standardized log format. Examples of the log transformer are a service hosted by the services platform with a well-known endpoint or it can be delivered as an agent that runs on the same host(s) as the service instance. The frequency of the log transforms can be configured by the service provider. At configuration time, the log transformer can be provided with the list of resources names from the service descriptor, so that it knows which log records to process and which log records to ignore, and a declaration of the log format (as shown in FIG. 4). At runtime, the log transformer can be provided with the list of log records since the last run and the service ID of the service instance. The log transformer can get the data via push or pull. In one embodiment, the service instance pushes its log records to the log transformer via a secure and authenticated channel.

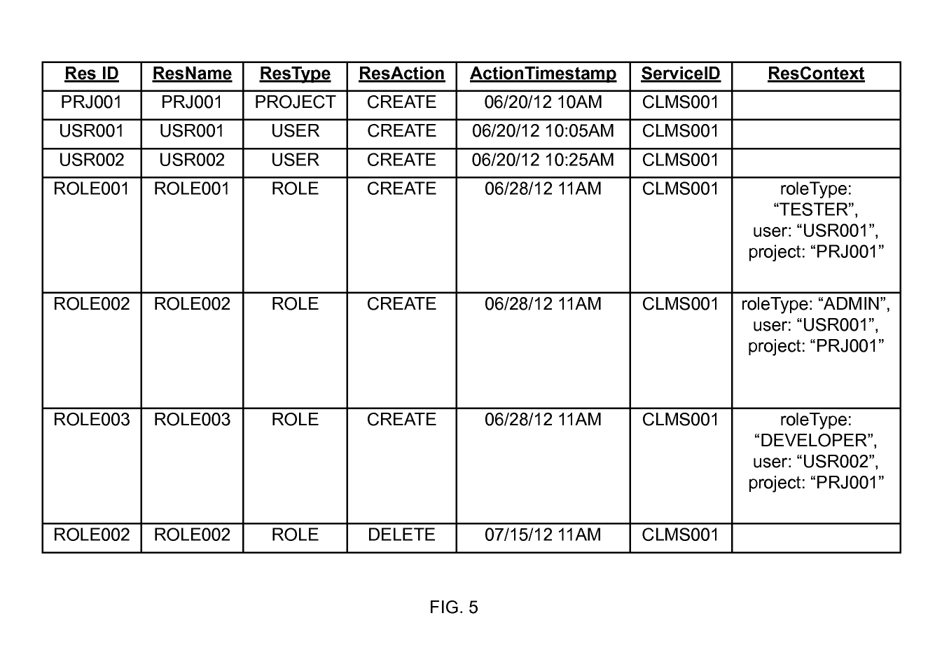

In at least one embodiment, service providers program and configure the log transformer for their service logs. This transformation can be programmed by using a variety of techniques such as Grok (http://code.google.com/p/semicomplete/wiki/Grok), sed/awk, or a visual tool. An example command line tool is shown in FIG. 4; and, an example standardized log is shown in FIG. 5.

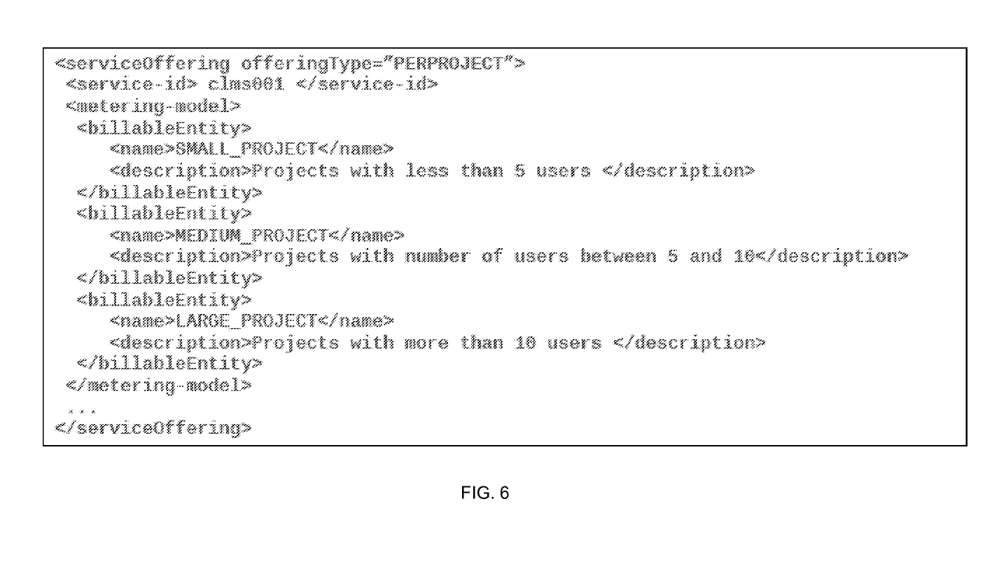

Offering managers can provide different ways in which a service can be offered. For every service offering, offering managers author a metering descriptor that describes billable entities for the service offering. FIG. 6 illustrates an example metering descriptor according to an embodiment of the invention.

Offering managers can program the BRG so that standardized log records can be converted into a metering record. Continuing with the example illustrated in FIG. 6, in order to generate a metering record for a SMALL_PROJECT, the BRG looks in the standardized logs for any project with less than 5 users. In the standardized log, the relationship between a user and a project is recorded in the resource_context column for a ROLE record.

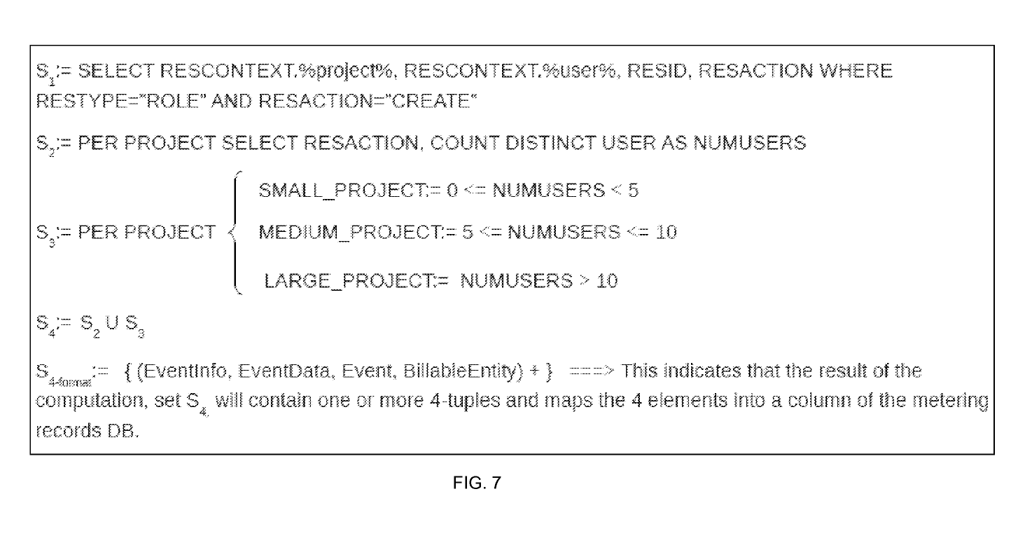

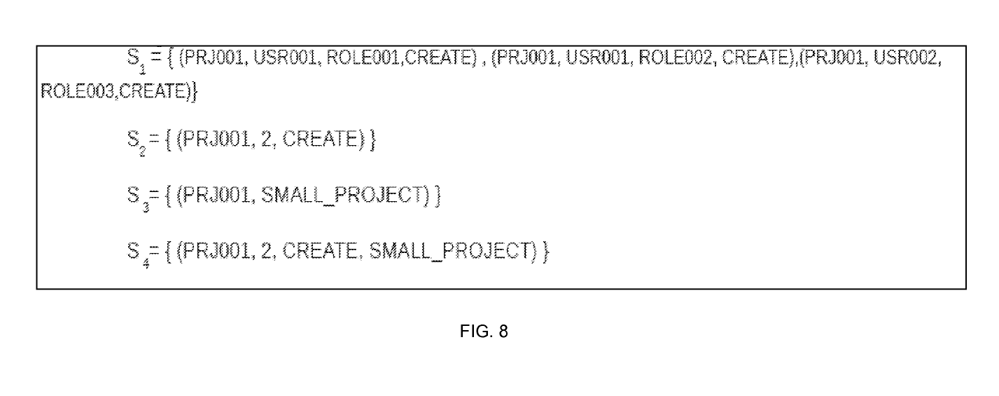

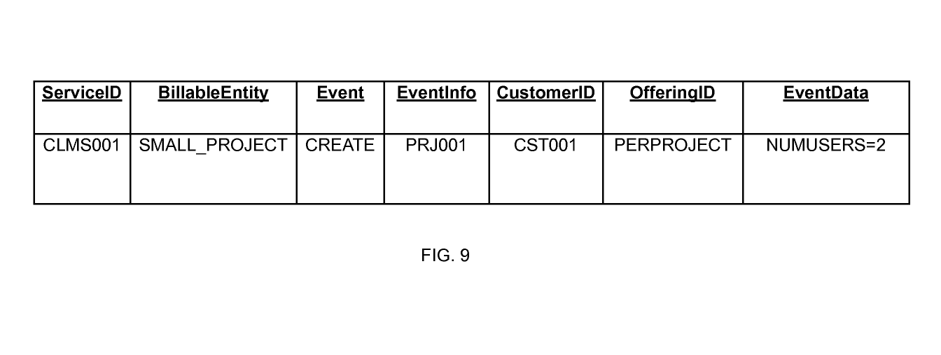

For each Project, roles can be selected and distinct users can be counted as user_count. If the user_count is less than 5, a metering record for SMALL_PROJECT can be created. If the user_count is greater than or equal to 5 and less than or equal to 10, then a metering record for MEDIUM_PROJECT can be created. If the user_count is greater than 10, a metering record for LARGE_PROJECT can be created. The services platform can support a concise language (e.g., elegant, terse, readable) that can be used by the offering manager to program the BRG. Additionally, the services platform can ensure the accuracy of BRGs through extensive testing. FIG. 7 illustrates example pseudocode for one way of how the transformation can be achieved. The sets illustrated in FIG. 8 result from the application of the pseudocode illustrated in FIG. 7 to the standardized log excerpt in FIG. 3. FIG. 9 illustrates an example metering record.

Accordingly, in at least one embodiment of the invention, the service developer can be reasonably expected to know about the resources that the service manipulates, without having to worry about generating billing records. Additionally, logging key lifecycle events for such resources can be done for all services for audit and/or troubleshooting purposes, and may not introduce undue overhead. With a clear specification of the standardized log format, and a platform supplied log transformer, service providers can program the log transformer so that their service logs can be converted into the specified format. The offering manager can manage the tasks of defining billable entities and transforming the standardized service logs into metering records by programming the BRG.

When the service's functions remain the same but the pricing model changes, the service does not need to be redesigned and/or rewritten. Redeployment may also not be necessary. The level of indirection in getting to a standard log from a service-specific one and programmable BRG can allow for sophisticated use cases such as including resources that do not exist on the same platform. Furthermore, the same notion of programmable BRGs that allow flexibility can also enable composable billing at the service abstraction level where a service billing function may leverage billing functions of component resources.

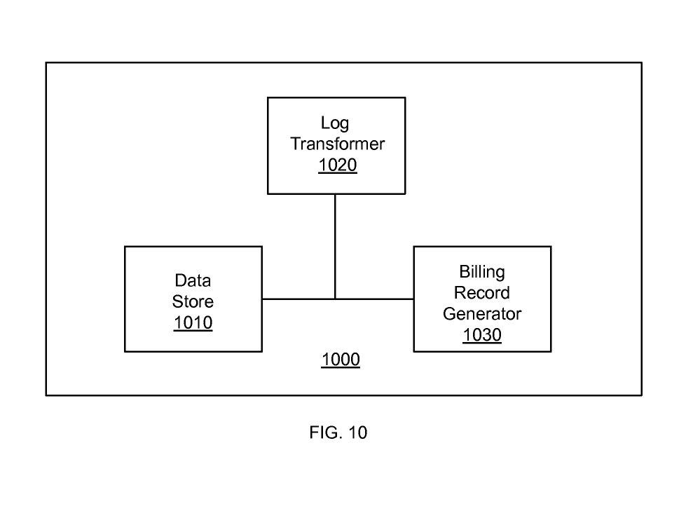

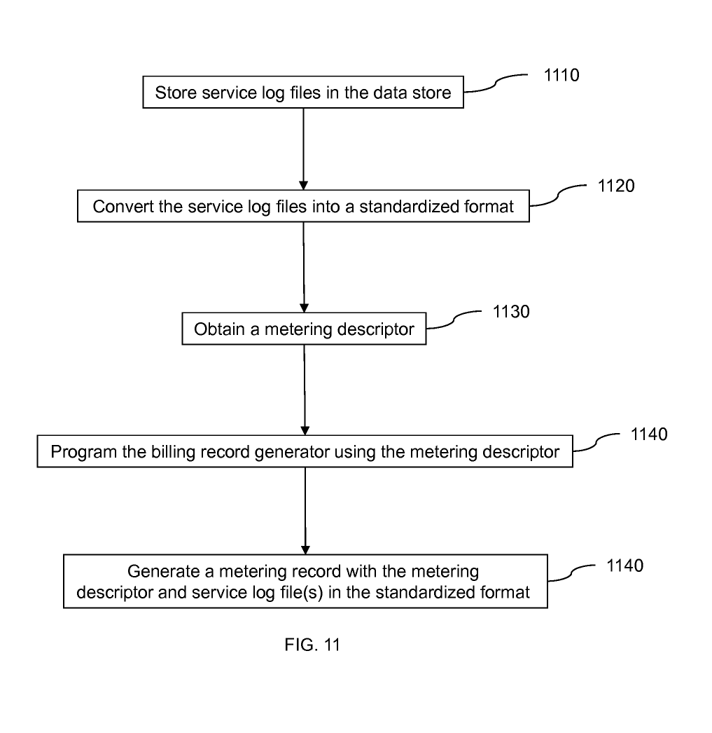

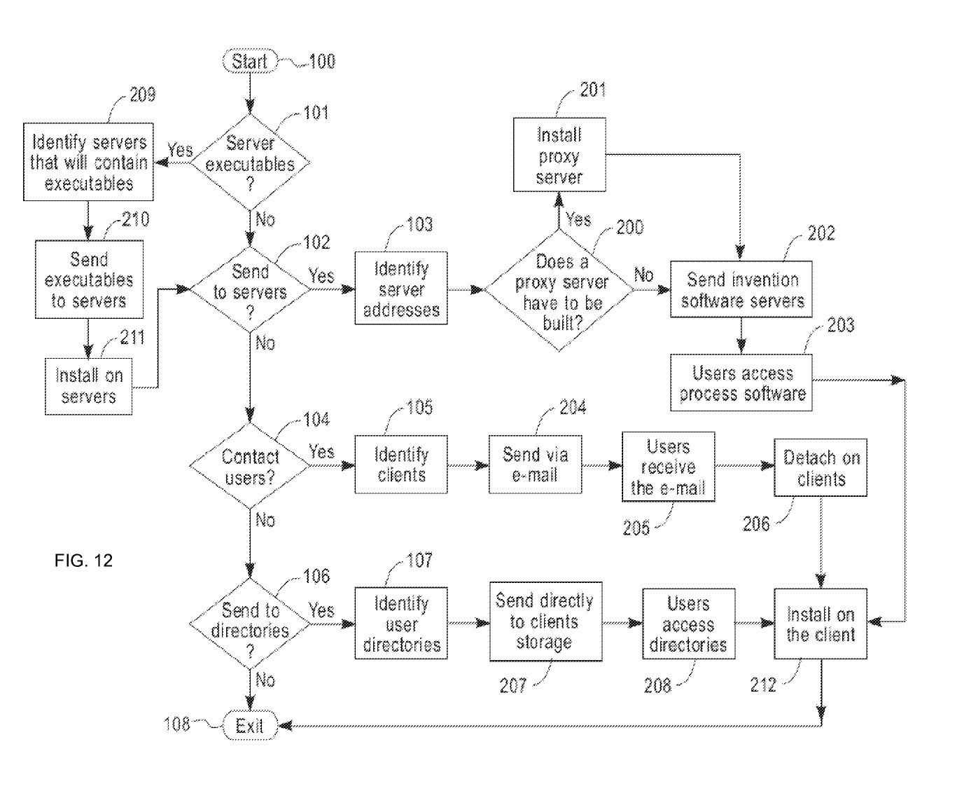

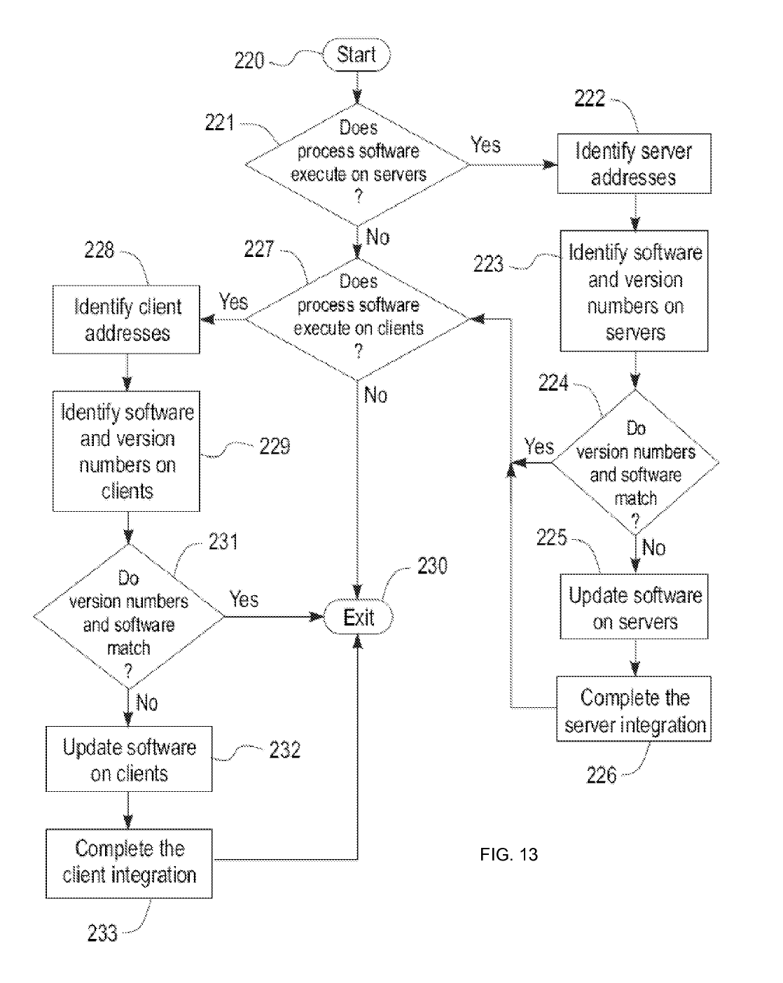

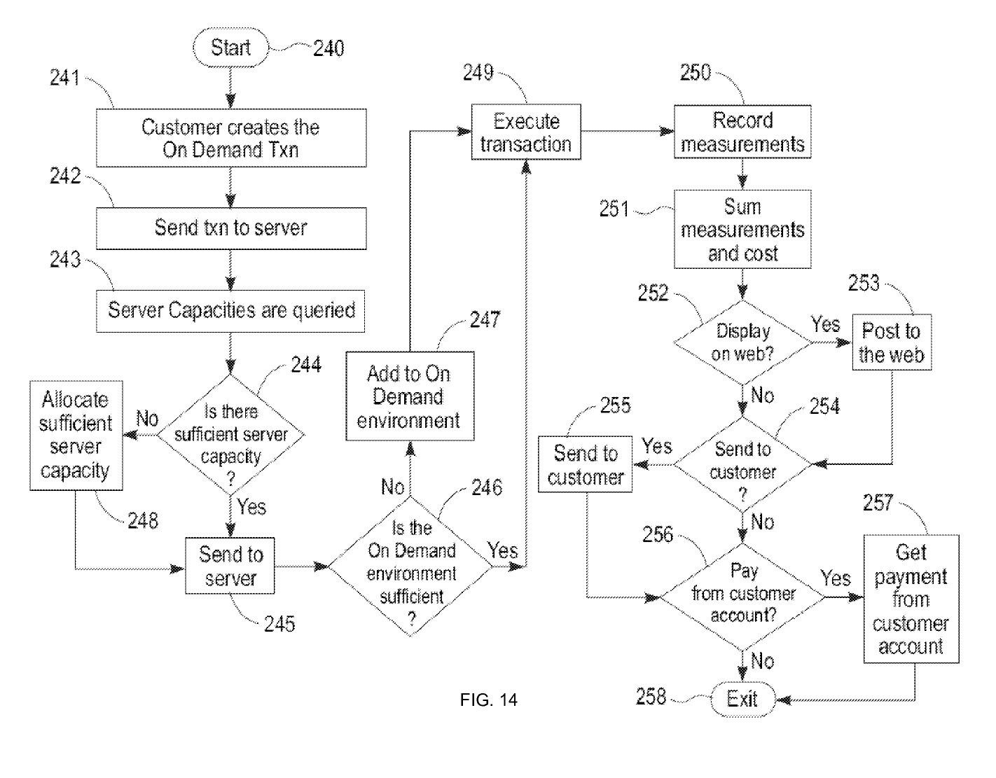

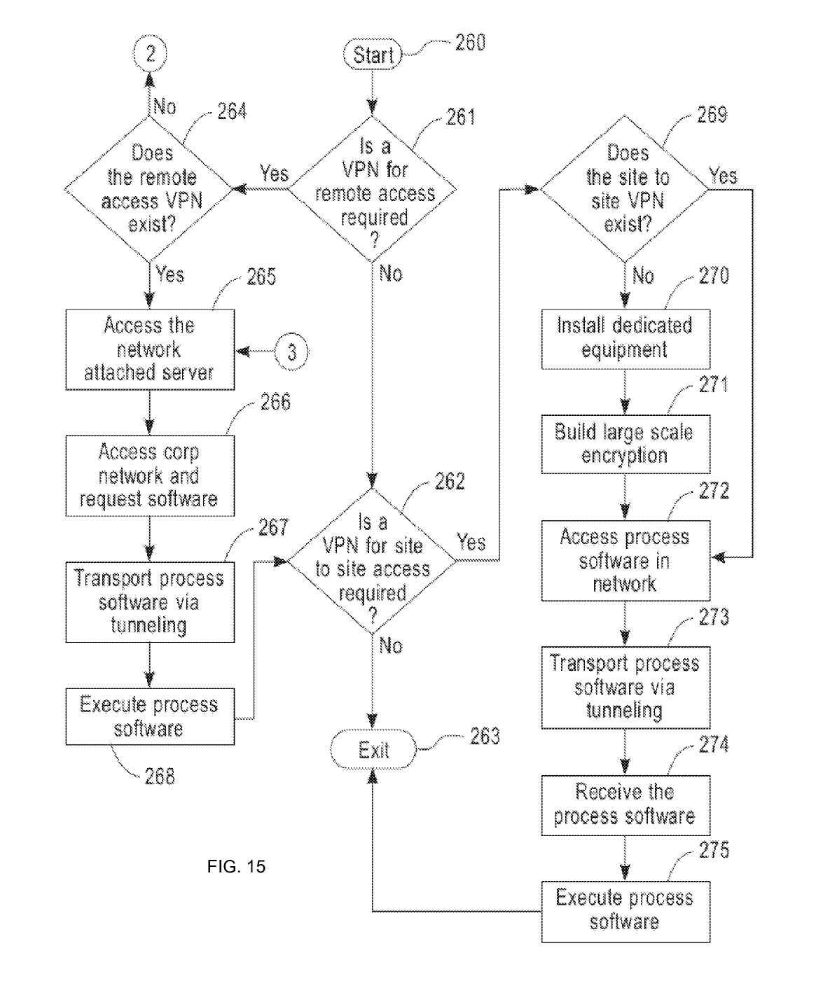

FIG. 10 is a diagram illustrating a system 1000 for non-intrusive cloud services billing according to an embodiment of the invention, wherein the system 1100 includes a data store 1010, a log transformer 1020, and a billing record generator 1030. FIG. 11 is a flow diagram illustrating a method for non-intrusive cloud services billing according to an embodiment of the invention, for example, using the system 1000.

As illustrated in FIG. 11, service log files are stored in the data store 1010 (1110). As used herein, the term “data store” includes a computer hardware device, such as, for example, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The data store 1010 can be configured to store the service log files. In at least one embodiment, the service log files are stored in one or more databases.

In at least one embodiment, each of the service log files include a lifecycle event of a resource in a service, wherein a service log file is produced by an instance of the service. Each event can describe an action on the resource and the context of that action. For example, a text message sent via a mobile telephone (i.e., an instance of a service) produces a log file that includes the time that the text message was sent, the telephone number of the recipient, and the size of the text message. Another example of an excerpt from a log file is illustrated in FIG. 3.

As used herein, the term “log transformer” includes, for example, a computer hardware device connected to the data store 1010. As used herein, the term “connected” includes operationally connected, logically connected, in communication with, physically or wirelessly connected, engaged, coupled, contacts, linked, affixed, and attached. The log transformer 1020 converts the service log files into a standardized format (1120). As described above, a standardized service log specification can be a document published by the services platform that describes the nature and format of the standardized service log. An example standardized log is illustrated in FIG. 5.

In at least one embodiment of the invention, the billing record generator editor obtains a metering descriptor from the offering manager (1130), wherein the metering descriptor describes billable entities for each offering of the service. The billable entities define how the services are billed and can include multiple categories of billing (e.g., small project, medium project, large project). Each offering of the service can have a different metering descriptor. An example metering descriptor is illustrated in FIG. 6.

The billing record generator editor can include a combination of hardware and software components. The billing record generator editor can program the billing record generator 1030 using the metering descriptor (1140). The billing record generator editor can use a visual tool that reads in the metering descriptor and facilitates the programming. Thus, the offering managers can program the billing record generator 1030 (via the billing record generator editor) for a specific service offering. The programming of the billing record generator 1030 can include writing of transformative logic to identify billable entities from within a collection of log files, wherein the transformative logic is written in any one of the concise languages supported by the services platform. A suite of tests can be run to ensure the accuracy of the program.

As used herein, the term “billing record generator” includes a computer hardware device connected to the log transformer 1020, wherein the billing record generator 1030 generates a metering record with the metering descriptor and one or more of the service log files in the standardized format (1150). As illustrated in the example metering record in FIG. 9, the metering record can include a service ID, a billable entity, an event, event information, a customer ID, an offering ID, and event data.

In at least one embodiment, a rating engine assigns a rating to the metering record based on the billable entity. Thus, for example, in FIG. 9, the rating is based on the billable entity SMALL_PROJECT. An invoice can be generated for the metering record based on the rating.

While it is understood that the process software may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server and then it will be stored on the proxy server.

Step 100 begins the deployment of the process software. The first thing is to determine if there are any programs that will reside on a server or servers when the process software is executed 101. If this is the case then the servers that will contain the executables are identified 209. The process software for the server or servers is transferred directly to the servers' storage via FTP or some other protocol or by copying though the use of a shared file system 210. The process software is then installed on the servers 211. Next, a determination is made on whether the process software is be deployed by having users access the process software on a server or servers 102. If the users are to access the process software on servers then the server addresses that will store the process software are identified 103.

A determination is made if a proxy server is to be built 200 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required then the proxy server is installed 201. The process software is sent to the servers either via a protocol such as FTP or it is copied directly from the source files to the server files via file sharing 202. Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems 203. Another embodiment is to have the servers automatically copy the process software to each client and then run the installation program for the process software at each client computer. The user executes the program that installs the process software on his client computer 212 then exits the process 108.

In step 104 a determination is made whether the process software is to be deployed by sending the process software to users via e-mail. The set of users where the process software will be deployed are identified together with the addresses of the user client computers 105. The process software is sent via email to each of the users' client computers. The users then receive the e-mail 205 and then detach the process software from the e-mail to a directory on their client computers 206. The user executes the program that installs the process software on his client computer 212 then exits the process 108.

Lastly a determination is made on whether to the process software will be sent directly to user directories on their client computers 106. If so, the user directories are identified 107. The process software is transferred directly to the user's client computer directory 207. This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software 208. The user executes the program that installs the process software on his client computer 212 then exits the process 108.

The process software is integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

Step 220 begins the integration of the process software. The first thing is to determine if there are any process software programs that will execute on a server or servers 221. If this is not the case, then integration proceeds to 227. If this is the case, then the server addresses are identified 222. The servers are checked to see if they contain software that includes the operating system (OS), applications, and network operating systems (NOS), together with their version numbers that have been tested with the process software 223. The servers are also checked to determine if there is any missing software that is required by the process software 223.

A determination is made if the version numbers match the version numbers of OS, applications and NOS that have been tested with the process software 224. If all of the versions match and there is no missing required software the integration continues in 227.

If one or more of the version numbers do not match, then the unmatched versions are updated on the server or servers with the correct versions 225. Additionally if there is missing required software, then it is updated on the server or servers 225. The server integration is completed by installing the process software 226.

Step 227 which follows either 221, 224 or 226 determines if there are any programs of the process software that will execute on the clients. If no process software programs execute on the clients the integration proceeds to 230 and exits. If this not the case, then the client addresses are identified 228.

The clients are checked to see if they contain software that includes the operating system (OS), applications, and network operating systems (NOS), together with their version numbers that have been tested with the process software 229. The clients are also checked to determine if there is any missing software that is required by the process software 229.

A determination is made is the version numbers match the version numbers of OS, applications and NOS that have been tested with the process software 231. If all of the versions match and there is no missing required software, then the integration proceeds to 230 and exits.

If one or more of the version numbers do not match, then the unmatched versions are updated on the clients with the correct versions 232. In addition, if there is missing required software then it is updated on the clients 232. The client integration is completed by installing the process software on the clients 233. The integration proceeds to 230 and exits.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements fuse such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

Step 240 begins the On Demand process. A transaction is created than contains the unique customer identification, the requested service type and any service parameters that further specify the type of service 241. The transaction is then sent to the main server 242. In an On Demand environment the main server can initially be the only server, and then as capacity is consumed other servers are added to the On Demand environment.

The server central processing unit (CPU) capacities in the On Demand environment are queried 243. The CPU requirement of the transaction is estimated, then the server's available CPU capacity in the On Demand environment is compared to the transaction CPU requirement to see if there is sufficient CPU available capacity in any server to process the transaction 244. If there is not sufficient server CPU available capacity, then additional server CPU capacity is allocated to process the transaction 248. If there was already sufficient Available CPU capacity then the transaction is sent to a selected server 245.

Before executing the transaction, a check is made of the remaining On Demand environment to determine if the environment has sufficient available capacity for processing the transaction. This environment capacity consists of such things as but not limited to network bandwidth, processor memory, storage etc. 246. If there is not sufficient available capacity, then capacity will be added to the On Demand environment 247. Next the required software to process the transaction is accessed, loaded into memory, and then the transaction is executed 249.

The usage measurements are recorded 250. The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer 251.

If the customer has requested that the On Demand costs be posted to a web site 252 then they are posted 253. If the customer has requested that the On Demand costs be sent via e-mail to a customer address 254 then they are sent 255. If the customer has requested that the On Demand costs be paid directly from a customer account 256 then payment is received directly from the customer account 257. The last step is exit the On Demand process.

The process software may be deployed, accessed and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets up a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

Step 260 begins the Virtual Private Network (VPN) process. A determination is made to see if a VPN for remote access is required 261. If it is not required, then proceed to 262. If it is required, then determine if the remote access VPN exists 264.

If it does exist, then proceed to 265. Otherwise identify the third party provider that will provide the secure, encrypted connections between the company's private network and the company's remote users 276. The company's remote users are identified 277. The third party provider then sets up a network access server (NAS) 278 that allows the remote users to dial a toll free number or attach directly via a cable or DSL modem to access, download and install the desktop client software for the remote-access VPN 279.

After the remote access VPN has been built or if it been previously installed, the remote users can then access the process software by dialing into the NAS or attaching directly via a cable or DSL modem into the NAS 265. This allows entry into the corporate network where the process software is accessed 266. The process software is transported to the remote user's desktop over the network via tunneling. That is, the process software is divided into packets and each packet including the data and protocol is placed within another packet 267. When the process software arrives at the remote user's desktop, it is removed from the packets, reconstituted and then is executed on the remote user's desktop 268.

A determination is made to see if a VPN for site to site access is required 262. If it is not required, then proceed to exit the process 263. Otherwise, determine if the site to site VPN exists 269. If it does exist, then proceed to 272. Otherwise, install the dedicated equipment required to establish a site to site VPN 270. Then build the large scale encryption into the VPN 271.

After the site to site VPN has been built or if it had been previously established, the users access the process software via the VPN 272. The process software is transported to the site users over the network via tunneling. That is, the process software is divided into packets and each packet including the data and protocol is placed within another packet 274. When the process software arrives at the remote user's desktop, it is removed from the packets, reconstituted and is executed on the site user's desktop 275. Proceed to exit the process 263.

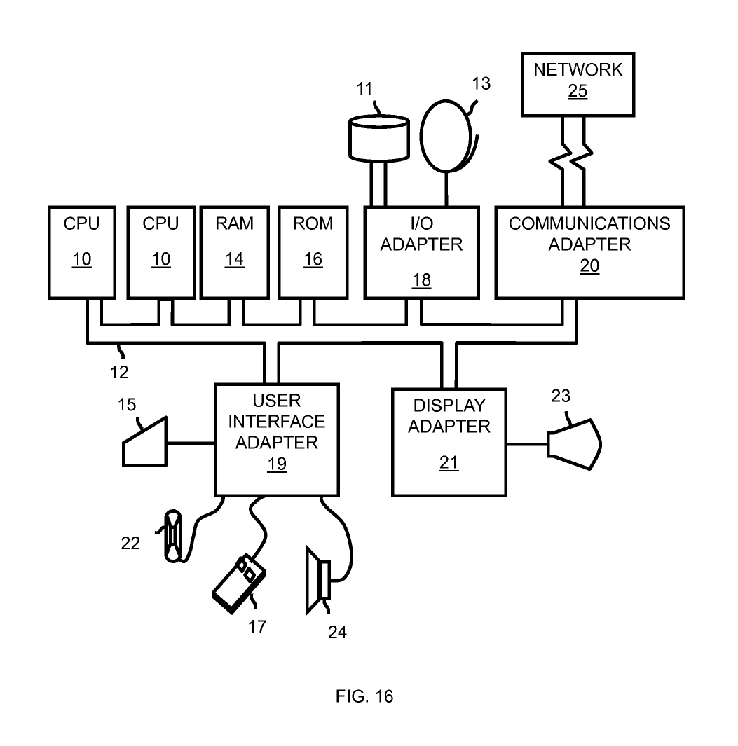

Referring now to FIG. 16, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (1/O) adapter 18. As used herein, device the term “device” also includes a computer, processor, switch, router, processing circuit, etc. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
storing service log files in a data store, each of the service log files including a lifecycle event of a resource in a service produced by an instance of the service;
converting the service log files into a standardized format;
obtaining a metering descriptor describing billable entities for each offering of the service, wherein the billable entities include multiple categories of billing; and
generating a metering record with the billing record generator, wherein the metering record is generated with at least one of the service log files in the standardized format and the metering descriptor.

2. The method according to claim 1, wherein the metering record includes a billable entity, a event, and event data.

3. The method according to claim 2, further comprising assigning a rating to the metering record based on the billable entity.

4. The method according to claim 3, further comprising generating an invoice for the metering record based on the rating.

5. The method according to claim 1, further comprising programming a billing record generator that converts standardized log records into metering records.

6. The method according to claim 5, wherein said programming of the billing record generator includes writing transformative logic to identify billable entities from a collection of standardized logs, the transformative logic being written in a language supported by a services platform.

7. The method according to claim 5, wherein said programming of the billing record generator includes using a visual tool to read the metering descriptor into the billing record generator and to facilitate said programming.

8. The method according to claim 1, wherein each offering of the service has a different metering descriptor.

9. The method according to claim 1, wherein the billable entities define how the services are billed.

10. The method according to claim 1, wherein offering managers program the billing record generator for a specific service offering.

11. A computer program product comprising:
a computer readable storage medium having stored thereon:
first program instructions executable by a device to cause the device to store service log files in a data store, each of the service log files including a lifecycle event of a resource in a service produced by an instance of the service;
second program instructions executable by the device to cause the device to convert the service log files into a standardized format;
third program instructions executable by the device to cause the device to obtain a metering descriptor describing billable entities for each offering of the service, wherein each offering of the service has a different metering descriptor, and wherein the billable entities include multiple categories of billing;
fourth program instructions executable by the device to cause the device to program a billing record generator that converts standardized log records into metering records; and
fifth program instructions executable by the device to cause the device to generate a metering record with the billing record generator, wherein the metering record is generated with at least one of the service log files in the standardized format and the metering descriptor, and wherein the metering record includes a billable entity, a event, and event data.

12. The computer program product according to claim 11, further comprising assigning a rating to the metering record based on the billable entity.

13. The computer program product according to claim 12, further comprising generating an invoice for the metering record based on the rating.

14. The computer program product according to claim 11, wherein said programming of the billing record generator includes writing transformative logic to identify billable entities from a collection of standardized logs, the transformative logic being written in a language supported by a services platform.

15. The computer program product according to claim 11, wherein said programming of the billing record generator includes using a visual tool to read the metering descriptor into the billing record generator and to facilitate said programming.

16. The computer program product according to claim 11, wherein the billable entities define how the services are billed.

17. The computer program product according to claim 11, wherein offering managers program the billing record generator for a specific service offering.

18. A system comprising:
a data store including service log files, each of the service log files including a lifecycle event of a resource in a service produced by an instance of the service;
a log transformer connected to said data store, said log transformer converts the service log files into a standardized format;
a billing record generator connected to said log transformer, said billing record generator generates a metering record with at least one of the service log files in the standardized format and a metering descriptor, wherein the metering descriptor describes billable entities for each offering of the service, and wherein the billable entities include multiple categories of billing.

19. The system according to claim 18, wherein the metering record includes a billable entity, a event, and event data.

20. The system according to claim 18, wherein each service offering has a different metering descriptor.
